(19) United States
(12) Patent Application Publication
(10) Pub. No.: US 2023/0313495 A1
(43) Pub. Date: Oct. 5, 2023

(54) SYSTEMS AND METHODS FOR AUTOMATICALLY STEERING A MOBILE MACHINE

(71) Applicant: Caterpillar Inc., Peoria, IL (US)

(72) Inventor: Randall T. ANDERSON, Peoria, IL (US)

(73) Assignee: Caterpillar Inc., Peoria, IL (US)

(21) Appl. No.: 17/657,429

(22) Filed: Mar. 31, 2022

(51) Int. Cl. E02F 9/20; G05D 1/00

(52) U.S. Cl. CPC E02F 9/2045; E02F 9/205; G05D 1/0061; G05D 1/0016; G05D 2201/0202

(57) ABSTRACT

A method of steering a mobile machine includes automatically steering the mobile machine in a forward direction to follow a grade line, and automatically steering the mobile machine in a reverse direction, based on a reverse mode selector setting of the mobile machine, to follow one of the grade line or a straight line.

### TECHNICAL FIELD

The present disclosure relates generally to operating mobile machinery, and more particularly, to systems and methods for automatically steering a mobile machine.

### BACKGROUND

Operators of mobile machinery may operate the mobile machinery in a reverse propulsion mode (e.g., moving the machinery backwards with respect to a longitudinal axis of the machine). When operating in reverse, it may be necessary to steer the vehicle in reverse in order to, for example, avoid obstacles, follow grade lines of a work site, or for other reasons.

Currently, methods of automatically operating mobile machinery may include methods and apparatuses for continuous operation near or around obstacles that are along a path (e.g., a path to be paved by paving equipment). U.S. Pat. No. 9,637,872 (“the '872 Patent”), describes methods and apparatuses for continuous operation near or around obstacles. The methods may include receipt of work materials onto a vehicle configured to distribute the materials, then automatically moving the vehicle while the vehicle completes a task (e.g., paving).

However, the '872 reference fails to describe automatic operation of a mobile machine in a dynamic reverse mode. Operators may require a dynamic reverse mode which may provide a selection between a straight line reverse and a grade line following reverse mode. At times, it may be advantageous to switch between the various modes. For example, if the operator is moving dirt around a feature (e.g., a tree) that has had a grade line drawn around the feature, and the operator needs to back the mobile machinery away from the feature, he or she may prefer to back up in a straight line rather than following the grade line as the mobile machine reverses near the feature. Features and aspects of the present disclosure may solve one or more of the problems set forth above and/or other problems in the art. The scope of the current disclosure, however, is defined by the attached claims, and not by the ability to solve any specific problem.

### SUMMARY

In one aspect, a method of steering a mobile machine includes automatically steering the mobile machine in a forward direction to follow a grade line, and automatically steering the mobile machine in a reverse direction, based on a reverse mode selector setting of the mobile machine, to follow one of the grade line or a straight line.

In another aspect, a method of steering a mobile machine includes selecting, between manual or automatic operation, an automatic operation mode of the mobile machine, automatically steering the mobile machine in a forward direction to follow a grade line, based on selection of the automatic operation mode, and automatically steering the mobile machine in a reverse direction, based on a reverse mode selector setting of the mobile machine, to follow one of the grade line or a straight line.

In yet another aspect, a system for automatically steering a mobile machine, the system comprising a propulsion module configured to operate in forward or reverse, a steering module configured to steer the mobile machine, a reverse mode selector for selecting a straight line following reverse mode or a grade line travel reverse mode, and a controller configured to cause the mobile machine to automatically reverse in a straight line, based on selection of the straight line following reverse mode and the propulsion module operating in reverse, and cause the mobile machine to automatically reverse to follow a grade line, based on selection of the grade line travel reverse mode and the propulsion module operating in reverse.

### BRIEF DESCRIPTION OF THE DRAWINGS

The accompanying drawings, which are incorporated in and constitute a part of this specification, illustrate various exemplary embodiments and together with the description, serve to explain the principles of the disclosed embodiments.

FIG. 1 is a schematic representation of a mobile machine according to aspects of the disclosure.

FIG. 2 is a schematic representation of an electronic control module for the mobile machine of FIG. 1.

FIG. 3 provides a flowchart depicting an exemplary method of operating the mobile machine of FIG. 1.

FIG. 4 depicts a scenario in which the mobile machine of FIG. 1 is reversed in a straight line reverse mode or a grade line following reverse mode.

### DETAILED DESCRIPTION

Both the foregoing general description and the following detailed description are exemplary and explanatory only and are not restrictive of the features, as claimed. As used herein, the terms “comprises,” “comprising,” “has,” “having,” “includes,” “including,” or other variations thereof, are intended to cover a non-exclusive inclusion such that a process, method, article, or apparatus that comprises a list of elements does not include only those elements, but may include other elements not expressly listed or inherent to such a process, method, article, or apparatus. In this disclosure, unless stated otherwise, relative terms, such as, for example, “about,” “substantially,” and “approximately” are used to indicate a possible variation of ±10% in the stated value.

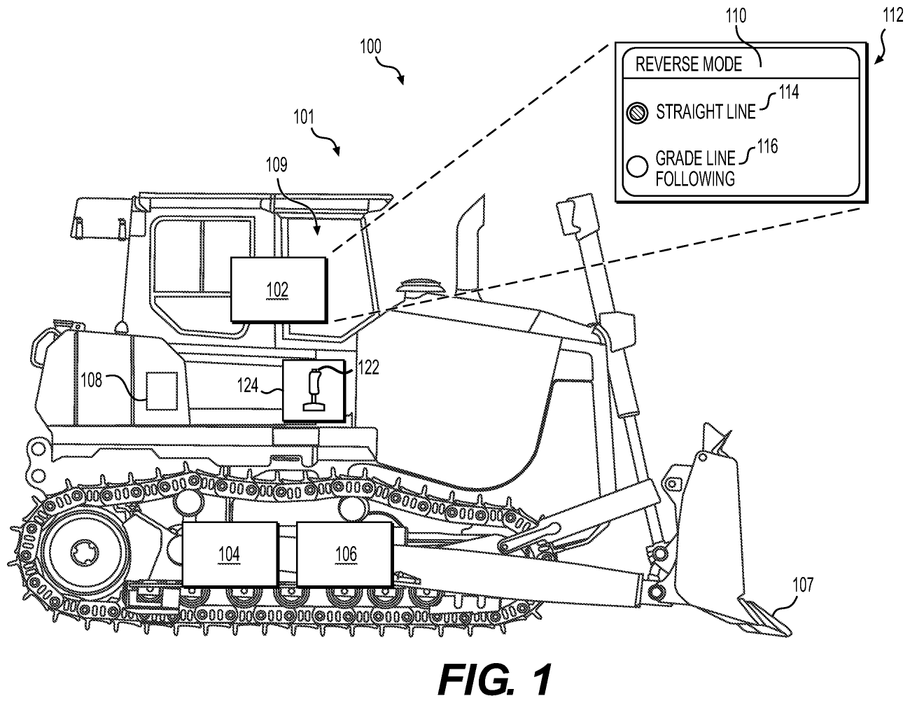

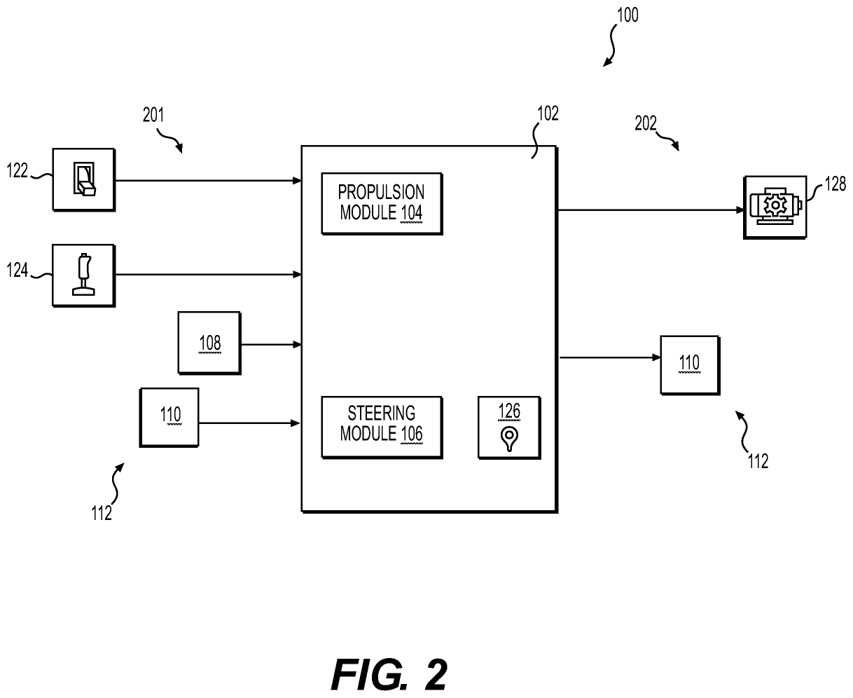

FIG. 1 illustrates a mobile machine 101 including a system 100 for automatically steering the mobile machine 101. As illustrated, the mobile machine 101 may be, for example, a track-type tractor. However, this disclosure is not so limited, and the mobile machine may be any type of mobile machine, such as, for example, a motor grader, or a compactor, or any other type of wheel- or track-driven machines capable of automatic and manual operation. The system 100 may include an electronic control module (ECM) 102, which may be communicatively coupled to a propulsion module 104 and a steering module 106, as described in greater detail herein, especially with respect to FIG. 2. The propulsion module 104 and the steering module 106 may interact to move the mobile machine 101 in the forward and reverse directions, steering the mobile machine 101 left and right as it moves in forward and reverse. In some embodiments, the mobile machine 101 may include one or more implements such as a blade, a ripper, a bucket, a grader, an auger, a backhoe, and other types of attachments. For example, as depicted in FIG. 1, the mobile machine 101 may include a blade 107. The blade 107 may be used to, for example, move earth, dirt, or other constituent as the mobile machine 101 is used to grade a plot.

In embodiments, the mobile machine 101 includes a sensor or other device or system for determining its own location. For example, the mobile machine 101 may include a sensor 108 for determining its location. The sensor 108 may be, for example, an inertial measurement unit, which may be capable of determining a location of the sensor 108 (and therefore the mobile machine 101 to which it is affixed). The sensor 108 may be a part of a sensor system (not depicted) which may include one or more physical sensors and/or virtual sensors (e.g., sensors that determine a value indirectly based on other sensed values) and may include any number and/or combination of sensors necessary for sensing or measuring conditions. The sensor 108 may be used, for example, to determine a location of the mobile machine 101 with respect to a grade line and/or as an input to the steering module 106 to steer the mobile machine 101 with respect to the grade line as described in greater detail herein. In some embodiments, a position of a left or right blade tip of the blade 107 may be determined by calculating from a frame of reference on the machine to the blade position by knowing the relative dimensions and positions of the blade 107 compared to a body of the mobile machine 101. A position of a left or right blade tip of the blade 107 may be used to determine a position of the mobile machine 101 with respect to a grade line as described in greater detail herein.

Still referring to FIG. 1, the mobile machine 101 may include a cabin 109 which may include, for example, a seat (not depicted) or other location to place an operator of the mobile machine 101. The operator may be capable of operating the mobile machine in an automatic or a manual mode. Within the cabin 109, or otherwise within reach of the operator, the mobile machine 101 may include one or more devices or systems for operating the mobile machine 101. For example, the mobile machine 101 may include one or more joysticks, knobs, buttons, touch screens, or other input/output devices for imparting one or more controls to the mobile machine 101. Briefly referring to FIGS. 1 and 2, a propulsion mode selector 122 (e.g., a switch, knob, dial, button, or other selector), a steering control 124 (e.g., a joystick, knob, dial, button, or other selector), and an input/output device such as the touch screen 112 of FIG. 1, which may include a display for displaying a reverse mode selector 110, may be within operational reach of the operator of the mobile machine 101. Though depicted schematically in FIGS. 1 and 2, the propulsion mode selector 122 and/or the steering control 124 may be, for example, near a seat for a driver pilot, or operator of the mobile machine 101. The touch screen 112 may be communicatively coupled to, for example, an electronic controller, such as the controller 102, and may be configured with a graphical user interface (GUI) which may be programmed to display one or more characteristics of the mobile machine 101 to an operator of the machine. For example, the touch screen 112 may display the reverse mode selector 110 to the operator. The reverse mode selector 110 may present the operator with the option to select a straight line reverse mode 114 or a grade line following reverse mode 116. The straight line reverse mode 114 and the grade line following reverse mode 116 may serve as inputs to the steering module 106 to steer the mobile machine 101 as described in greater detail herein. Some embodiments of the mobile machine 101 may include a forward mode selector (not shown). The forward mode selector may present the operator with, for example, the option to select a straight line forward mode or a grade line following forward mode.

Referring now to FIG. 2, the ECM 102 for the mobile machine 101 of FIG. 1 is shown in greater detail. The ECM 102 may be communicatively coupled to or otherwise include one or more modules or systems for carrying out one or more functions of the mobile machine 101 and may include inputs 201 and outputs 202. For example, the ECM 102 may be communicatively coupled to the propulsion module 104, the steering module 106, the sensor 108, the touchscreen 112 (which may be configured to display the reverse mode selector 110 of FIG. 1), and a navigation module 126. The ECM 102 may include a single processor or multiple processors configured to receive inputs, display outputs, and generate commands to control the operation of components of the system 100.

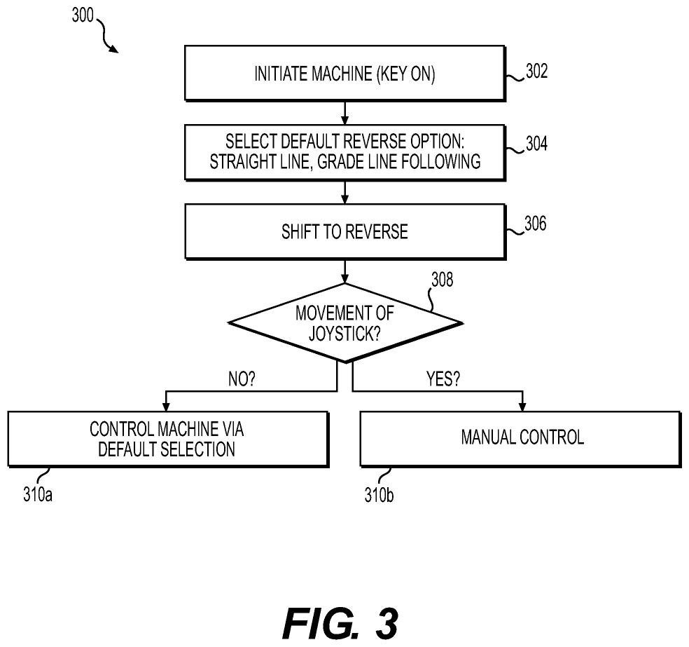

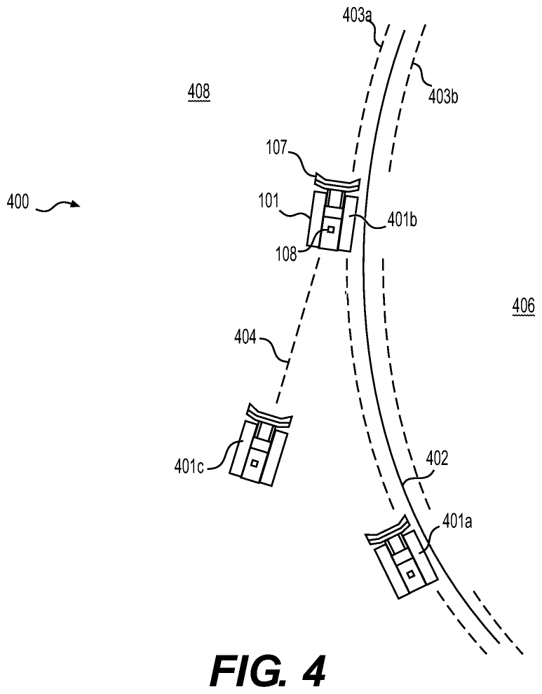

ECM 102 may include a memory, a secondary storage device, processor(s), such as central processing unit(s), networking interfaces, or any other means for accomplishing tasks consistent with the present disclosure. The memory or secondary storage device associated with ECM 102 may store data and software to allow ECM 102 to perform its functions, including the functions described below with respect to method 300 (FIG. 3) and the functions of the system 100 described with respect to FIG. 4. One or more of the devices or systems communicatively coupled to the ECM 102 may be communicatively coupled over a wired or wireless network, such as the Internet, a Local Area Network, WiFi, Bluetooth, or any combination of suitable networking arrangements and protocols.

Still referring to FIG. 2, the propulsion module 104 may receive an input from one or more of the propulsion mode selector 122 or the steering control 124 of FIG. 1. Based on the inputs, the propulsion module 104 may cause the mobile machine 101 to move in a forward or a reverse direction with respect to a longitudinal axis of the mobile machine (not depicted). The propulsion module 104 may operate in an automatic or a manual mode based on one or more settings of the inputs to the propulsion module 104. For example, the propulsion module 104 may cause the mobile machine 101 to operate in an automatic forward and reverse propulsion mode based on a position of the propulsion mode selector 122, which may have one or more settings, such as a “forward,” “reverse,” and “neutral” settings, and the steering control 124. The operator may cause the mobile machine 101 to automatically move forward, for example, by placing the propulsion mode selector 122 in the forward setting and to automatically move backward, for example, by placing the propulsion mode selector 122 in the reverse setting. The steering control 124 may receive an operator input to steer left or right or may allow the control system to determine in which direction the mobile machine 101 is steered if the steering control 124 is in a central (i.e., neutral) position. By leaving the steering control 124 in the center position (not left or right) the operator allows the control system to maintain straight line following or grade line following in the reverse mode based on the position of the reverse mode selector 110.

The steering module 106 may receive inputs from one or more of the steering control 124, the sensor 108, or the navigation module 126. Based on the steering mode of operation of the mobile machine 101, the mobile machine 101 may use one or more of these inputs to steer in an automatic or a manual mode. For example, the mobile machine 101 may use the sensor 108 and the navigation module 126 to automatically steer left and right with respect to a longitudinal axis (not depicted) of the mobile machine 101 when in the automatic steering mode. The mobile machine 101 may use an input from the steering control 124 to steer when in the manual steering mode. For example, an operator of the mobile machine 101 may move the steering control 124 in the left or right direction to manually move the mobile machine 101 in the left or right direction, respectively.

The navigation module 126 may receive inputs from one or more sensors (e.g., the sensor 108) or one or more other systems capable of determining a location of the mobile machine 101 (e.g., GPS, INU, IMU, etc.) The navigation module 126 may store one or more aspects or features of a planned route or work site of the mobile machine 101 for automatically steering the mobile machine 101 with respect to the planned route or work site. For example, the navigation module 126 may store one or more computer-aided design (CAD) files or other files which may include information related to, for example (without limitation), elevations, routes, slopes, grades, surface characteristics, pavement or ground characteristics or types, or other features or aspects of a work site of the mobile machine. The navigation module 126 may store one or more grade lines or features of a predetermined site plan or plans. Grade lines may be, for example, a curve or other plotted feature of a work site, which the mobile machine 101 would follow in order to complete a job such as, for example, grading, excavating, filling, moving, or other work.

Still referring to FIG. 2, the steering module 106 may receive an input from the reverse mode selector 110 (via the touch screen 112, for example). The selection of the reverse mode selector 110 may cause the steering module 106 to cause the mobile machine 101 to reverse in a straight line reverse mode or a grade line following reverse mode when the mobile machine is operated automatically and in a reverse mode as explained in greater detail herein. The steering module 106 may receive one or more inputs from and provide one or more inputs to, for example, a steering motor 128. In embodiments in which the mobile machine 101 uses a steering motor, the steering motor 128 may control one or more aspects of the mobile machine 101 to steer. For example, the mobile machine 101 may include one or more tracks and the steering motor 128 may be an electric or hydraulic steering motor that may change a rotational input to a drive sprocket of the one or more tracks to steer the machine. However, other types of steering systems are capable of implementation to steer the mobile machine 101 without limitation.

Referring to FIG. 3, a method 300 for dynamically and automatically operating a mobile machine in a reverse mode is shown. At step 302, an operator may start the mobile machine 101. For example, an operator may turn an ignition key, press a “start” start button, or otherwise activate the propulsion system and steering system of the mobile machine 101.

Once the mobile machine 101 is started, the user may select a reverse steering mode of the mobile machine 101. For example, the user may select a straight line reverse steering mode or a grade line following reverse steering mode at step 304. In some embodiments, the system 100 may selectively default to either the straight line following or the grade line following reverse steering mode when the system 100 is initiated based on a user input.

With the mobile machine 101 in a straight line reverse steering mode the mobile machine 101 may automatically reverse in a straight line as described in greater detail herein. Conversely, with the mobile machine 101 in a grade line following reverse steering mode, the mobile machine 101 may automatically follow a grade line when the mobile machine 101 is operated in reverse, as described in greater detail herein.

At step 306, the operator may shift the mobile machine 101 to reverse. In some embodiments, the operator may change the position of a switch (e.g., the propulsion mode selector 122 of FIG. 2) to a “reverse” position to automatically place the mobile machine 101 in a reverse propulsion mode. The propulsion system of the mobile machine 101 may begin to move the mobile machine backwards.

At step 308, the mobile machine 101 may determine a position of the manual steer control 124 to determine whether the operator intends to operate the steering systems of the mobile machine 101 in manual control. If the manual steer control 124 is in the default or neutral position (i.e., the operator has not moved the manual steer control 124), the ECM 102 may determine that the user does not intend to operate the mobile machine 101 in the manual mode and thus the automatic steering controls may control the movement of the mobile machine 101.

Step 310a shows the scenario in which the operator does not take manual steering control of the mobile machine 101. That is, the operator does not move the manual steer control 124 to steer the mobile machine 101 while it is operated in a reverse mode. Hence, when the operator shifts the propulsion mode to reverse to back up the mobile machine 101, the operator leaves the manual steer control 124 in the neutral position and the mobile machine 101 reverses from its current position. More specifically, if the reverse mode selector 110 is in the straight line reverse mode, the mobile machine 101 will automatically reverse in a straight line. If the reverse mode selector 110 is in the grade line following mode, the mobile machine 101 will automatically follow the grade line in reverse, retracing its tracks along the grade line. In embodiments, the system 100 may default to automatic steering control in either the straight line or grade line following modes without operator input to the steering control 124.

Step 310b shows the scenario in which the operator moves the manual steer control 124 of the mobile machine 101 and manual steers the mobile machine. That is, at step 310b, the operator initiates a manual override of the steering system by moving the manual steer control 124 and the mobile machine 101 is manual steered by the operator. For example, the operator may reverse the mobile machine 101 and may move the mobile machine 101 left and right by moving the manual steer control 124 left and right, respectively.

### INDUSTRIAL APPLICABILITY

The disclosed aspects of the systems and methods for automatically steering a mobile machine using a dynamic reverse mode of the present disclosure may be used in conjunction with any appropriate machine, vehicle or other mobile machine or system. The dynamic reverse mode for a mobile machine may be applied, for example, to a track-type tractor, a motor grader, a compactor, or other mobile machine.

Referring now to FIG. 4, an exemplary use of the mobile machine 101 of FIG. 1 is described. FIG. 4 shows a top view of the mobile machine 101 including the blade 107 and the sensor 108. The mobile machine 101 is following a grade line 402. The grade line 402 may be, for example, a line drawn in a computer-aided drafting program following a predetermined site plan 400. For example, the grade line 402 may follow a grade, an elevation, a route, a slope, a surface characteristic, a pavement type, or other feature or aspect of a work site of the mobile machine 101. The mobile machine 101 may follow the grade line 402 for various reasons, for example, to grade the surface at the grade line 402 using the blade 107.

In some embodiments, the mobile machine 101 may engage an automatic steering mode when within a capture range of the grade line 402 (as indicated by left capture line 403a and right capture line 403b) of the grade line 402 based on operator-selected settings of the mobile machine 101. For example, the operator may select forward propulsion of the mobile machine 101 with the mobile machine 101 in an automatic steering mode (e.g., by placing the propulsion mode selector switch 122 in a “forward” position), or by placing a forward mode selector switch in a grade line following forward mode and causing the mobile machine 101 to move forward. Subsequently, when the mobile machine moves forward to within the capture range 403 (e.g., approaches the left capture line 403a), the mobile machine 101 may begin to automatically follow the grade line 402 (e.g., based on a forward steering operation mode (e.g., with grade line following forward mode selected using, for example, the touch screen 112).

The capture range may be a measured distance from the grade line 402 (e.g., two feet) based on a sensing capability of the mobile machine 101 to sense its location with respect to the grade line 402. The mobile machine 101 may be determined to be within the capture range using one or more of the sensor 108 or one or more components of the ECM 102, for example, the steering module 106 and the navigation module 126. For example, the ECM 02 may receive one or more inputs from the sensor 108 (which may include or otherwise be in communication with, for example, an onboard GPS system) to determine when the mobile machine 101 is within the capture range 403. In some embodiments, the mobile machine 101 may be configured to switch to an automatic steering mode when within the capture range 403 of the grade line 402. That is, the mobile machine 101 may be operating in a manual steering mode until the operator of the mobile machine 101 drives the mobile machine 101 within the capture range 403 of the grade line 402 and then the mobile machine 101 may automatically engage automatic steering to automatically steer the mobile machine following the grade line 402. This automatic transition from manual steering control to automatic steering control may occur, for example, based on the mobile machine 101 operating below a particular speed and based on a selection of a grade line following forward mode selection (e.g., using the touch screen 112 of FIGS. 1 and 2).

In the particular example shown in FIG. 4, the mobile machine 101 is within the capture range 403 of the grade line 402. Hence, the mobile machine 101 operates in a forward propulsion mode, automatically steering around the curve from position 401a to position 401b. Once at the position 401b, the operator of the mobile machine 101 places the mobile machine 101 in the reverse propulsion mode. The operator may change the propulsion mode, for example, using the propulsion mode selector 122 (FIG. 2). Once the propulsion mode is in the reverse mode, the mobile machine 101 may begin to reverse.

Depending on the selection provided, the mobile machine 101 will reverse in the straight line reverse mode or the grade line following reverse mode. For example, the operator may select a reverse mode using the reverse mode selector 110 (FIG. 1). If the reverse mode selector 110 is in the grade line following reverse mode, the mobile machine 101 will reverse following the grade line 402. Hence, the mobile machine 101 will reverse from position 401b back toward position 401a. If the reverse mode selector 110 is in the straight line reverse mode, the mobile machine 101 will reverse in the straight line reverse mode from position 401b to position 401c. In some embodiments, the steering module 106 may calculate an infinite turn radius and use the inverse radius to calculate a zero degree turn, hence reversing the mobile machine 101 in a straight direction 404 from 401b to 401c.

In some embodiments, the reverse mode selector 110 may have a default setting. For example, in some embodiments, the reverse mode selector 110 may default to a straight line reverse mode. That is, when the mobile machine 101 is operating in an automatic steering mode, following a grade line, for example, and the operator places the propulsion mode selector 122 in the reverse direction, the reverse mode selector 110 may default to the straight line reverse mode.

The process described with relation to FIG. 4 assumes that the operator of the mobile machine 101 does not take manual control of the mobile machine 101 using the manual steer control 124. If the operator decides to take manual control (as in step 310b), the mobile machine 101 may be steered while operating in forward or reverse using the manual steer control 124 (e.g., a joystick). That is, the operator may reach point 401b in automatic steering mode with the mobile machine 101 following the grade line 402 and the operator may then determine to steer the mobile machine 101 left, or right.

The systems and methods laid out in the foregoing detailed description provide a system for automatically steering a mobile machine in a straight line reverse mode or grade line following reverse mode so that an operator can automatically steer a mobile machine in reverse along a straight line or along a grade line, as desired. This may allow an operator to adjust the position of a mobile machine when necessary to reposition the mobile machine with respect to an object, feature, or other aspect of a worksite. Hence, operators of mobile machines are provided additional mobility and flexibility to better accomplish their goals. The systems and methods laid out herein also provide better machine control by providing for control of the mobile machine in different modes of steering the vehicle between the forward and reverse modes. That is, the operator could cause the mobile machine to operate in the grade line following forward mode and the straight line reverse mode.

It will be apparent to those skilled in the art that various modifications and variations can be made to the disclosed system without departing from the scope of the disclosure. Other embodiments of the system will be apparent to those skilled in the art from consideration of the specification and practice of the system disclosed herein. It is intended that the specification and examples be considered as exemplary only, with a true scope of the disclosure being indicated by the following claims and their equivalents.

What is claimed is:

1. A method of steering a mobile machine comprising:
automatically steering the mobile machine in a forward direction to follow a grade line; and
automatically steering the mobile machine in a reverse direction, based on a reverse mode selector setting of the mobile machine, to follow one of the grade line or a straight line.

2. The method of claim 1, wherein the reverse mode selector setting is an operator selected setting.

3. The method of claim 1, wherein the reverse mode selector setting is selected prior to automatically steering the mobile machine in the forward and reverse directions.

4. The method of claim 1, wherein the mobile machine is one of a track-type tractor, a motor grader, or a compactor.

5. The method of claim 1, wherein the grade line is based on a predetermined site plan.

6. The method of claim 1, wherein automatically steering the mobile machine in the reverse direction is initiated based on an operator input of a propulsion mode selector.

7. The method of claim 1, wherein automatic steering of the mobile machine is controlled by a controller and the controller is configured to discontinue automatic steering of the mobile machine based on an operator input from a steering control.

8. The method of claim 1, wherein automatic steering of the mobile machine is controlled by a controller, the controller having a default to cause the mobile machine to follow the straight line in the reverse direction.

9. A method of steering a mobile machine, comprising:
selecting, between manual or automatic operation, an automatic operation mode of the mobile machine;
automatically steering the mobile machine in a forward direction to follow a grade line, based on selection of the automatic operation mode; and
automatically steering the mobile machine in a reverse direction, based on a reverse mode selector setting of the mobile machine, to follow one of the grade line or a straight line.

10. The method of claim 9, wherein the mobile machine defaults to the automatic operation mode without operator input from a steering control.

11. The method of claim 9, wherein the selection between manual or automatic operation modes of the mobile machine is made using input from a propulsion mode selector.

12. The method of claim 9, wherein the reverse mode selector setting is selected prior to automatically steering the mobile machine in the forward and reverse directions.

13. The method of claim 9, wherein the grade line is based on a predetermined site plan.

14. The method of claim 9, wherein the mobile machine is one of a track-type tractor, a motor grader, or a compactor.

15. A system for automatically steering a mobile machine, the system comprising:
a propulsion module configured to operate in forward or reverse;
a steering module configured to steer the mobile machine;
a reverse mode selector for selecting a straight line following reverse mode or a grade line travel reverse mode; and
a controller configured to:
cause the mobile machine to automatically reverse in a straight line, based on selection of the straight line following reverse mode and the propulsion module operating in reverse; and
cause the mobile machine to automatically reverse to follow a grade line, based on selection of the grade line travel reverse mode and the propulsion module operating in reverse.

16. The system for automatically steering a mobile machine of claim 15, wherein the controller is further configured to initiate a manual override of the automatic steering control based on a position of a manual steer control.

17. The system for automatically steering a mobile machine of claim 15, wherein the reverse mode selector is selected using a touch screen.

18. The system for automatically steering a mobile machine of claim 15, wherein the mobile machine is one of a track-type tractor, a motor grader, or a compactor.

19. The system for automatically steering a mobile machine of claim 15, further comprising:
at least one sensor affixed to the mobile machine and configured to sense a position of the at least one sensor with respect to the grade line; and
the reverse mode selector automatically selects to the grade line travel reverse mode when the at least one sensor is within a capture range of the grade line.

20. The system for automatically steering a mobile machine of claim 15, wherein the grade line is based on a predetermined site plan.
